(19) United States
(12) Patent Application Publication
(10) Pub. No.: US 2026/0193128 A1
(43) Pub. Date: Jul. 9, 2026

(54) GLASS FOR COVERING SEMICONDUCTOR ELEMENT, MATERIAL FOR COVERING SEMICONDUCTOR ELEMENT, AND SINTERED BODY FOR COVERING SEMICONDUCTOR ELEMENT

(71) Applicant: NIPPON ELECTRIC GLASS CO., LTD., Otsu-shi, Shiga (JP)

(72) Inventor: Masayuki HIROSE, Otsu-shi, Shiga (JP)

(73) Assignee: NIPPON ELECTRIC GLASS CO., LTD., Otsu-shi, Shiga (JP)

(21) Appl. No.: 18/863,099

(22) PCT Filed: Jun. 16, 2023
(86) PCT No.: PCT/JP2023/022407

§ 371 Date: Nov. 5, 2024

(30) Foreign Application Priority Data
Jun. 29, 2022 (JP) 2022-104342
Sep. 28, 2022 (JP) 2022-154523
Mar. 29, 2023 (JP) 2023-052803

(51) Int. Cl. C03C 10/00; C03B 19/06

(52) U.S. Cl. CPC C03C 10/00; C03B 19/06

(57) ABSTRACT

A glass for covering a semiconductor element, the glass includes, by mol %, 30% to less than 53% of SiO₂, 15% to 30% of ZnO, 2% to 14% of Al₂O₃, 0 to 10% of B₂O₃, more than 11% to 30% of MgO+CaO as a glass composition, and includes substantially no lead component.

### TECHNICAL FIELD

The present invention relates to glass for covering a semiconductor element, a material for covering a semiconductor element, and a sintered body for covering a semiconductor element.

### BACKGROUND ART

Generally, in a semiconductor element such as a silicon diode or a transistor, a surface of the semiconductor element including a P-N junction is covered by glass. Accordingly, it is possible to stabilize the surface of the semiconductor element and prevent degradation of characteristics over time.

The characteristics required for a glass for covering a semiconductor element are (1) that a thermal expansion coefficient matches a thermal expansion coefficient of the semiconductor element so as not to cause a crack or the like due to a difference in thermal expansion coefficient from the semiconductor element, (2) covering can be performed at a low temperature (for example, 900° C. or lower) to prevent the degradation of the characteristics of the semiconductor element, and (3) that no impurity such as an alkali component that adversely affects the surface of the semiconductor element is not contained.

In the related art, zinc-based glass such as ZnO—B₂O₃—SiO₂-based glass, and lead-based glass such as PbO—SiO₂—Al₂O₃-based glass and PbO—SiO₂—Al₂O₃—B₂O₃-based glass are known as the glass for covering a semiconductor element. However, at present, lead-based glass such as PbO—SiO₂—Al₂O₃-based glass and PbO—SiO₂—Al₂O₃—B₂O₃-based glass is mainly used from the viewpoint of workability (for example, see Patent Literatures 1 to 4).

### CITATION LIST

### Patent Literature

Patent Literature 1: JPS48-43275A
Patent Literature 2: JPS50-129181A
Patent Literature 3: JPH1-49653B2
Patent Literature 4: JP2008-162881A

### SUMMARY OF INVENTION

### Technical Problem

However, a lead component of the lead-based glass is harmful to the environment. In addition, since the zinc-based glass contains a small amount of a lead component and a bismuth component, it cannot be said that the zinc-based glass is completely harmful to the environment.

Further, the zinc-based glass tends to have a high thermal expansion coefficient of glass, and when a surface of a semiconductor element such as Si is covered, a crack may be generated or a warpage may occur in the semiconductor element.

On the other hand, when a content of SiO₂ in a glass composition is increased, the thermal expansion coefficient is decreased, a reverse voltage of the semiconductor element is increased, and the semiconductor element is less likely to fail. However, when the reverse voltage increases, a problem arises where a reverse leakage current of the semiconductor element increases. In particular, since the reverse leakage current becomes a problem in a low withstand voltage semiconductor element, it is necessary to prevent the reverse leakage current to reduce a surface charge density of the glass.

The present invention is in view of the above circumstances, and a technical object thereof is to provide a glass for covering a semiconductor element, which has a small environmental load, a low thermal expansion coefficient, and a low surface charge density.

### Solution to Problem

As a result of intensive studies, the present inventors have found that the above technical problems can be solved by using SiO₂—ZnO—Al₂O₃-based glass having a specific glass composition, and have proposed the present invention. That is, the glass for covering a semiconductor element of the present invention contains: by mol %, 30% to less than 53% of SiO₂, 15% to 30% of ZnO, 2% to 14% of Al₂O₃, 0 to 10% of B₂O₃, more than 11% to 30% of MgO+CaO as a glass composition, and contains substantially no lead component. Here, “MgO+CaO” refers to a total content of MgO and CaO. The phrase “contains substantially no . . . ” means that the corresponding component is not intentionally added as a glass component, and does not mean that impurities that are inevitably mixed are completely eliminated. Specifically, it means that a content of the corresponding component including the impurity is less than 0.1 mass %.

As described above, the glass for covering a semiconductor element of the present invention regulates a content range of each component. Accordingly, an environmental load decreases, a thermal expansion coefficient becomes low, and a surface charge density decreases.

As a result, the glass can be suitably used for covering a low withstand voltage semiconductor element.

It is preferable that in the glass for covering a semiconductor element of the present invention, Zn₂SiO₄ is contained as a main crystal after heat treatment. Here, the “heat treatment” refers to a heat treatment at 800° C. to 1000° C. for 10 minutes or more.

It is preferable that a material for covering a semiconductor element of the present invention includes a glass powder made of the glass for covering a semiconductor element as described above.

It is preferable that in the material for covering a semiconductor element of the present invention, a thermal expansion coefficient in a temperature range of 30° C. to 300° C. after heat treatment is 20×10⁻⁷/° C. or more and 48×10⁻⁷/° C. or less. Accordingly, it is easy to avoid a situation in which a crack or warpage occurs in the semiconductor element. Here, the “thermal expansion coefficient in a temperature range of 30° C. to 300° C.” refers to a value measured by a push rod type thermal expansion coefficient measuring device.

In a sintered body for covering a semiconductor element of the present invention, Zn₂SiO₄ is contained as a main crystal, and a volume ratio of Zn₂SiO₄ is 10% to 40%. The sintered body for covering a semiconductor element is obtained by thermally treating the material for covering a semiconductor element.

In the sintered body for covering a semiconductor element of the present invention, Zn₂SiO₄ is contained as a main crystal, and a porosity of the sintered body is 10% or less.

It is preferable that the sintered body for covering a semiconductor element of the present invention, further contains: by mol %, 30% to less than 53% of SiO₂, 15% to 30% of ZnO, 2% to 14% of Al₂O₃, 0 to 10% of B₂O₃, more than 11% to 30% of MgO+CaO as a glass composition, and contains substantially no lead component.

### Advantageous Effects of Invention

According to the present invention, it is possible to provide glass for covering a semiconductor element, which has a small environmental load, a low thermal expansion coefficient, and a low surface charge density.

### DESCRIPTION OF EMBODIMENTS

Glass for covering a semiconductor element of the present invention contains by mol %, 30% to less than 53% of SiO₂, 15% to 30% of ZnO, 2% to 14% of Al₂O₃, 0 to 10% of B₂O₃, more than 11% to 30% of MgO+CaO as a glass composition, and contains substantially no lead component. The reason for limiting a crystal phase and a content of each component will be described above. In the description of the content of each component, % means mol % unless otherwise specified. Unless otherwise stated, in the present description, a numerical range indicated using “to” means a range that includes the numerical values listed before and after “to” as the minimum value and the maximum value, respectively.

SiO₂ is a network-forming component of glass and is a component that increases acid resistance. SiO₂ is also a constituent component of Zn₂SiO₄. A content of SiO₂ is 30% to less than 53%, preferably 30% to 52%, 30% to 51%, 30% to 50%, 30% to less than 50%, 32% to 48%, and particularly preferably 35% to 45%. When the content of SiO₂ is too small, a thermal expansion coefficient tends to increase, and the acid resistance tends to decrease. In addition, Zn₂SiO₄ is less likely to precipitate, the thermal expansion coefficient of a covering material becomes too high, and a warpage at the time of firing covering becomes large. On the other hand, when the content of SiO₂ is too large, a firing temperature becomes too high, and a covering layer cannot be formed at an appropriate temperature.

ZnO is a component that stabilizes the glass. ZnO is also a constituent component of Zn₂SiO₄. A content of ZnO is 15% to 30%, preferably 17% to 28%, 19% to 26%, 19.5% to less than 25%, and particularly preferably 20% to 24%. When the content of ZnO is too small, a devitrification property at the time of melting becomes strong, making it difficult to obtain homogeneous glass. In addition, Zn₂SiO₄ is less likely to precipitate, the thermal expansion coefficient of a covering material becomes too high, and a warpage at the time of firing covering becomes large. On the other hand, when the content of ZnO is too large, the acid resistance tends to decrease. In addition, a crystallinity becomes too strong, a viscosity rapidly increases during firing, and defects such as bubbles are easily contained in the covering material.

SiO₂+ZnO (a total content of SiO₂ and ZnO) is preferably 45% to less than 80%, 50% to 70%, and particularly preferably 55% to less than 65%. When the total content of SiO₂+ZnO is too small, Zn₂SiO₄ is less likely to precipitate, the thermal expansion coefficient of the covering material becomes too high, and the warpage at the time of firing covering becomes large. On the other hand, when the total content of SiO₂+ZnO is too large, the crystallinity becomes too strong, the viscosity rapidly increases during firing, and defects such as bubbles are easily contained in the covering material.

Al₂O₃ is a component that adjusts a surface charge density and stabilizes the glass. A content of Al₂O₃ is preferably 2% to 14%, 4% to 12%, and particularly preferably 5% to 10%. When the content of Al₂O₃ is too small, the glass is easily devitrified during forming. On the other hand, when the content of Al₂O₃ is too large, the surface charge density may become too large.

B₂O₃ is a network-forming component of the glass and is a component that increases softening fluidity. A content of B₂O₃ is 0 to 10%, preferably 0 to 7%, 0 to 5%, and particularly preferably 0 to 3%. When the content of B₂O₃ is too large, it becomes difficult to crystallize the glass, and the acid resistance tends to decrease.

MgO and CaO are components for decreasing the viscosity of the glass. A total content of MgO and CaO is more than 11% to 30%, preferably 12% to 28%, 15% to 25%, and particularly preferably 16% to 24%. When the total content of MgO and CaO is too small, the firing temperature of the glass tends to increase. On the other hand, when the total content of MgO and CaO is too large, the thermal expansion coefficient may become too high, a chemical resistance may decrease, and an insulation may decrease.

From the viewpoint of the environment, it is preferable that substantially no lead component (for example, PbO) is contained and substantially no Bi₂O₃, F, or Cl is contained. In addition, it is preferable that an alkali component (Li₂O, Na₂O, and K₂O) which adversely affects the surface of the semiconductor element is substantially not contained.

In addition to the above components, other components (for example, SrO, BaO, MnO₂, Nb₂O₅, Ta₂O₅, CeO₂, and Sb₂O₃) may be contained up to 7% (preferably up to 3%).

It is preferable that in the glass for covering a semiconductor element of the present invention, Zn₂SiO₄ is contained as a main crystal after heat treatment. Zn₂SiO₄ has a thermal expansion coefficient that is extremely close to silicon which is a covering target of the glass of the present invention, and has a function of significantly preventing the occurrence of the warpage during the firing after the covering. In addition to Zn₂SiO₄, a crystal such as ZnAl₂O₄ may be contained simultaneously.

A volume ratio of Zn₂SiO₄ is preferably 10% to 40%, 12% to 35%, and particularly preferably 15% to 30%. When the volume ratio of Zn₂SiO₄ is too small, the thermal expansion coefficient of the covering material becomes too high, and the warpage during the firing after the covering becomes large. On the other hand, when the volume ratio of Zn₂SiO₄ is too large, the viscosity of the glass is rapidly increased at a softening point or more, and defects such as bubbles are easily included. The “volume ratio of Zn₂SiO₄” refers to a numerical value obtained by performing background removal on a peak of Zn₂SiO₄ obtained by an X-ray diffraction method, dividing an integrated intensity of a sharp peak of a crystal phase by an integral intensity of a broad peak of an amorphous layer (glass), and multiplying the integrated intensity by a factor of 100.

It is preferable that the material for covering a semiconductor element of the present invention contains a material obtained by processing the glass for covering a semiconductor element into a powder shape, that is, a glass powder. When the material is processed into the glass powder, the surface of the semiconductor element can be easily covered with, for example, a paste method, an electrophoresis coating method, or the like. Thereafter, the surface of the semiconductor element can be covered with a sintered body for covering a semiconductor element by thermally treating the material for covering a semiconductor element.

An average particle size D₅₀ of the glass powder is preferably 25 μm or less, and particularly preferably 15 μm or less. When the average particle size D₅₀ of the glass powder is too large, it is difficult to form a paste. Powder adhesion by the electrophoresis method also becomes difficult. A lower limit of the average particle size D₅₀ of the glass powder is not particularly limited, but is practically 0.1 μm or more. The “average particle size D₅₀” refers to a value measured on a volume basis, and indicates a value measured by a laser diffraction method.

The glass powder can be obtained, for example, by mixing raw material powders of respective oxide components to form a batch, melting the powers at about 1500° C. for about one hour to vitrify, and then forming (thereafter, grinding and classifying if necessary). In the material for covering a semiconductor element of the present invention, the thermal expansion coefficient in the temperature range of 30° C. to 300° C. after the heat treatment is preferably 20×10⁻⁷/° C. or more and 48×10⁻⁷/° C. or less, and particularly preferably 30×10⁻⁷/° C. or more and 45×10⁻⁷/° C. or less. When the thermal expansion coefficient is out of the above range, cracks, warpages, and the like due to a difference in the thermal expansion coefficient from the semiconductor element are likely to occur.

In the material for covering a semiconductor element of the present invention, the surface charge density after the heat treatment is preferably 10×10¹¹/cm² or less, and particularly preferably 8×10¹¹/cm² or less when the surface of a semiconductor element having, for example, 1500V or less is covered. When the surface charge density is too high, the withstand voltage is improved, but a leakage current tends to increase at the same time. The “surface charge density” refers to a value measured by a method described in a column of Examples described later.

The sintered body for covering a semiconductor element of the present invention contains Zn₂SiO₄ as a main crystal. It is preferable that the sintered body for covering a semiconductor element contains, by mol %, 30% to less than 53% of SiO₂, 15% to 30% of ZnO, 2% to 14% of Al₂O₃, 0 to 10% of B₂O₃, more than 11% to 30% of MgO+CaO as a glass composition, and contains substantially no lead component. A preferable range of the content of each component of the sintered body for covering a semiconductor element and a preferable range of a precipitation amount of Zn₂SiO₄ are the same as those of the glass for covering a semiconductor element.

A porosity of the sintered body for covering a semiconductor element of the present invention is preferably 10% or less, 8% or less, and particularly preferably 5% or less. When the porosity is too high, the covering may become insufficient, which may adversely affect the withstand voltage. In reality, a lower limit of the porosity is 0.1% or more.

It is also possible to prepare the sintered body for covering a semiconductor element containing Zn₂SiO₄ as the main crystal by mixing a nucleating agent such as ZnO powder with an amorphous glass powder and then subjecting the mixed powder to the heat treatment.

### EXAMPLES

Hereinafter, the present invention will be described in detail based on Examples. Note that the following Examples are merely illustrative. The present invention is not limited to the following Examples in any way.

Table 1 shows examples of the present invention (Sample Nos. 1 to 5) and comparative examples (Sample Nos. 6 to 9).

TABLE 1

| (mol %) | No. 1 | No. 2 | No. 3 | No. 4 | No. 5 | No. 6 | No. 7 | No. 8 | No. 9 |
|---|---|---|---|---|---|---|---|---|---|
| SiO₂ | 41 | 44 | 36 | 48 | 51 | 28 | 38 | 33 | 30 |
| ZnO | 23 | 20 | 28 | 29 | 17 | 20 | 45 | 50 | 35 |
| Al₂O₃ | 9 | 7 | 5 | 8 | 8 | 18 | 7 | 8 | 10 |
| B₂O₃ | 4 | 8 | 8 | 0 | 2 | 18 | 0 | 0 | 8 |
| MgO | 13 | 15 | 13 | 8 | 14 | 10 | 7 | 7 | 10 |
| CaO | 10 | 6 | 10 | 7 | 8 | 6 | 3 | 2 | 7 |
| MgO + CaO | 23 | 21 | 23 | 15 | 22 | 16 | 10 | 9 | 17 |
| Volume ratio of | 28 | 22 | 32 | 39 | 17 | 0 | 45 | 47 | Devitrification |
| Zn₂SiO₄ (%) | | | | | | | | | |
| Thermal expansion | 40 | 42 | 39 | 37 | 41 | 53 | 34 | 34 | Unmeasurable |
| coefficient (×10⁻⁷/° C.) | | | | | | | | | |
| Surface charge density | 9 | 7 | 4 | 6 | 7 | 9 | 4 | 7 | Unmeasurable |
| (×10¹¹/cm²) | | | | | | | | | |
| Defect inclusion status | ∘ | ∘ | ∘ | ∘ | ∘ | ∘ | x | x | Unmeasurable |
| Amount of warpage | 230 | 290 | 210 | 170 | 250 | 510 | 150 | 150 | Unmeasurable |
| (μm) | | | | | | | | | |
| Porosity (%) | 3 | 3 | 2 | 3 | 2 | 2 | 25 | 27 | Unmeasurable |

Each sample was prepared as follows. First, raw material powders were mixed to have a glass composition in the table to prepare a batch, and were melted and vitrified at 1500° C. for 1 hour. Subsequently, the molten glass was formed into a film shape, ground by a ball mill, and classified using a 350 mesh sieve to obtain a glass powder having an average particle size D₅₀ of 12 μm.

For each sample, the volume ratio of Zn₂SiO₄, the thermal expansion coefficient, the surface charge density, the defect inclusion status, the amount of warpage, and the porosity were evaluated. The results are shown in Table 1.

The volume ratio of Zn₂SiO₄ was measured as follows. The glass powder was molded into a button shape, subjected to heat treatment at 800° C. to 950° C. for 10 minutes, ground in a mortar, obtained a diffraction peak by an X-ray diffractometer, and subjected to background removal. Then an integrated intensity of a peak derived from the crystal was divided by an integrated intensity of a peak derived from the glass for a peak attributed to Zn₂SiO₄, and 100 was multiplied.

The thermal expansion coefficient was a value measured in a temperature range of 30° C. to 300° C. using a push rod type thermal expansion coefficient measuring device using a sample obtained by thermally treating at 800° C. to 950° C. for 10 minutes as a measurement sample.

The surface charge density was measured as follows. First, each sample was dispersed in an organic solvent and adhered to a surface of a silicon substrate to have a constant film thickness by electrophoresis, and then fired at a temperature at which crystallization proceeded to form a covering layer. Next, after an aluminum electrode was formed on the surface of the covering layer, a change in capacitance in the covering layer was measured using a C-V meter to calculate the surface charge density.

The defect inclusion status was measured as follows. The glass on the silicon substrate fired as described above was observed with a stereomicroscope, and was evaluated as “∘” when bubbles having a diameter of 10 μm or more were not observed, and evaluated as “x” when bubbles were observed.

The amount of warpage was measured as follows. First, the silicon substrate was placed on a surface plate to be convex downward, and any point on a circumference of the silicon substrate was closely fixed to the surface plate with a double-sided tape. Next, a displacement of a height on a straight line passing through a center of a circle and a fixing point of the silicon substrate was measured using a laser displacement meter. A difference between a maximum point and a minimum point of the obtained displacement was calculated, and the difference was evaluated as the amount of warpage. When the amount of warpage is 300 μm or less, it can be said that the amount of warpage is small.

The porosity was measured as follows. First, the glass powder and a photoresist liquid were mixed and uniformly applied on a smooth silicon substrate having a known weight. Next, after the firing was performed at 500° C. for 1 hour and at 950° C. for 20 minutes, a thickness of a glass sintered film was measured with a micrometer, and a weight was measured to determine a bulk density of the glass sintered film. Next, “(density of glass density-bulk density of sintered film)/density of glass” was calculated to obtain the porosity.

As is apparent from Table 1, the thermal expansion coefficients, the surface charge densities, and the amounts of warpage of the samples Nos. 1 to 5 showed desired values. In addition, the defect inclusion status was also good. Accordingly, it is considered that the samples Nos. 1 to 5 are suitable as the material for covering a semiconductor element used for covering a low withstand voltage semiconductor element.

On the other hand, in Sample No. 6, the crystal did not precipitate, the thermal expansion coefficient was high, and the evaluation of the amount of warpage was poor. Samples No. 7 and No. 8 had high crystallinity and contained defects due to a rapid increase in viscosity during firing. Sample No. 9 had too strong a devitrification property and could not be formed into glass.

1. A glass for covering a semiconductor element, the glass comprising, by mol %, 30% to less than 53% of SiO₂, 15% to 30% of ZnO, 2% to 14% of Al₂O₃, 0 to 10% of B₂O₃, more than 11% to 30% of MgO+CaO as a glass composition, and comprising substantially no lead component.

2. The glass for covering a semiconductor element according to claim 1, wherein Zn₂SiO₄ is contained as a main crystal after heat treatment.

3. A material for covering a semiconductor element, the material comprising, a glass powder made of the glass for covering a semiconductor element according to claim 1.

4. The material for covering a semiconductor element according to claim 3, wherein a thermal expansion coefficient in a temperature range of 30° C. to 300° C. after heat treatment is 20×10⁻⁷/° C. or more and 48×10⁻⁷/° C. or less.

5. A sintered body for covering a semiconductor element, wherein Zn₂SiO₄ is contained as a main crystal, and a volume ratio of Zn₂SiO₄ is 10% to 40%.

6. A sintered body for covering a semiconductor element, wherein Zn₂SiO₄ is contained as a main crystal, and a porosity of the sintered body is 10% or less.

7. The sintered body for covering a semiconductor element according to claim 5, the sintered body further comprising, by mol %, 30% to less than 53% of SiO₂, 15% to 30% of ZnO, 2% to 14% of Al₂O₃, 0 to 10% of B₂O₃, more than 11% to 30% of MgO+CaO as a glass composition, and comprising substantially no lead component.
